(19) United States
(12) Patent Application Publication
(10) Pub. No.: US 2009/0250976 A1
(43) Pub. Date: Oct. 8, 2009

(54) Automobile roof frame with X-shaped coupling structure

(76) Inventor: Tai-Her Yang, Dzan-Hwa (TW)

Correspondence Address: BACON & THOMAS, PLLC, 625 SLATERS LANE, FOURTH FLOOR, ALEXANDRIA, VA, 22314-1176, US

(21) Appl. No.: 12/078,900

(22) Filed: Apr. 8, 2008

(51) Int. Cl. B62D 25/06; B62D 23/00

(52) U.S. Cl. 296/225; 280/790

(57) ABSTRACT

The present invention is to construct the roof frame of an automobile which extends forward and backward along both sides that bended from top to down and extends forward and backward in parallel or approximately parallel into a multi-sectional X-shaped coupling structure at the front, rear or front and rear of parallel or approximately parallel frame bended downward along both sides, whereby to strengthen its rigidity and to have a roof frame with special modeling.

### BACKGROUND OF THE INVENTION

(a) Field of the Invention

The present invention is related to an externally supported type roof frame structure of an automobile, more specifically, it is coupled by two U-shaped frames that appearing X-shaped coupling structure to construct an innovative design of better rigidity and flexible modeling.

(b) Description of the Prior Art

The roof frame of conventional automobiles are usually forward and backward in parallel or approximately parallel along both sides of the bodywork to execute a downward bended structure, which are subjected to the drawbacks of less rigidity and limited modeling.

### SUMMARY OF THE INVENTION

The present invention is related to an innovation of an automobile roof frame, more specifically it is a roof frame structure being forward and backward extended along both sides of the car body to bend downwardly and being forward and backward extended in parallel or approximately parallel, thereby to construct specified coupling structures include: (1) the front downward bended parallel or approximately parallel frame is constructed into multi-sectionally X-shaped coupling structure; or (2) the rear downward bended parallel or approximately parallel frame is constructed into multi-sectionally X-shaped coupling structure; or (3) the front and rear parallel or nearly parallel frame that bended downward along both sides of the car body is constructed into multi-sectionally X-shaped coupling structure, thereby to strengthen its rigidity and to have a roof frame with special modeling.

### BRIEF DESCRIPTION OF THE DRAWINGS

FIG. 1 is the embodiment schematic view of the present invention illustrating that the front downward bended roof frames in dual opposite arc shape at both sides are coupled in X-shape multi-sectionally.

### DESCRIPTION OF MAIN COMPONENT SYMBOLS

100: Car body
101: U-shaped short frame
103: Coupling structure
111, 112, 211, 212: fixed arm
113: U-shaped top end
114, 214: transverse arm
200: roof device
201: U-shaped long frame
213: U-shaped bottom end

### DETAILED DESCRIPTION OF THE PREFERRED EMBODIMENTS

The present invention is related to an innovation of an automobile roof frame, more specifically it is a roof frame structure being forward and backward extended along both sides of the car body to bend downwardly and being forward and backward extended in parallel or approximately parallel, thereby to construct specified coupling structures include: (1) the front downward bended parallel or approximately parallel frame is constructed into multi-sectionally X-shaped coupling structure; or (2) the rear downward bended parallel or approximately parallel frame is constructed into multi-sectionally X-shaped coupling structure; or (3) the front and rear parallel or nearly parallel frame that bended downward along both sides of the car body is constructed into multi-sectionally X-shaped coupling structure, thereby to strengthen its rigidity and to have a roof frame with special modeling.

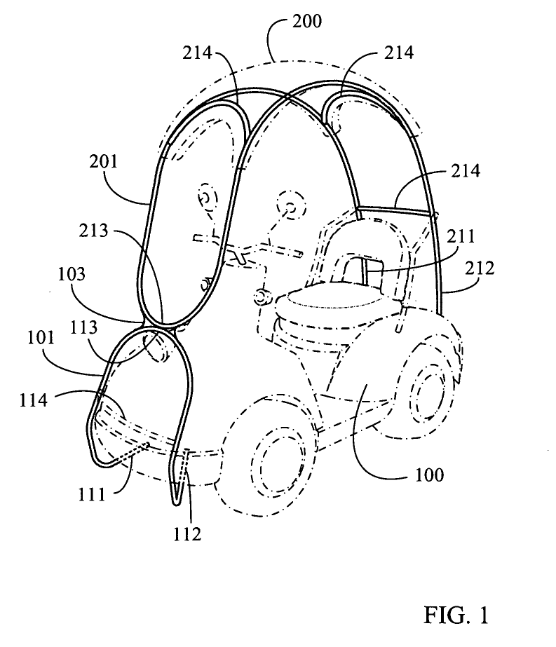

As illustrated in FIG. 1 is the embodiment schematic view of the present invention illustrating that the front downward bended roof frames in dual opposite arc shape at both sides are coupled in X-shape multi-sectionally; it mainly comprises:

U-shaped short frame (101): it is a reversed U-shaped structure which is constituted by metal tube shape or stick shape material, wherein the fixed arms (111), (112) extending downward at both sides are combined to the front of the car body (100), and the U-shaped top end (113) and the U-shaped bottom end (213) of the U-shaped long frame (201) is coupled in X-shape at the coupling structure (103) to jointly constituted a roof frame. The fixed arms (111), (112) extended at both sides of the U-shaped short frame (101) can be constituted by a single tube, or can be optionally installed with an auxiliary arm as required to constitute multi-arms that combined to the car body (100); a transverse arm (114) to improve its strength and rigidity can be optionally installed between fixed arms (111) and (112) as required;

U-shaped long frame (201): it is an U-shaped structure which is constituted by metal tube shape or stick shape material, wherein its both sides are extended toward top portion for disposing a roof device (200), or an optionally installed windshield and related apparatus before the fixed arms (211), (212) are extended downward to be combined with the rear of the car body (100), and the U-shaped long frame (201) leading to the U-shaped bottom end (213) at front and the U-shaped top end (113) of the U-shaped short frame (101) are coupled in X shape at the coupling structure (103) to jointly constitute the roof frame. The fixed arms (111), (112) extended at both sides of the U-shaped long frame (201) can be constituted by a single tube, or can be optionally installed with an auxiliary arm as required to constitute multi-arms that combined to the car body (100); a transverse arm (114) to improve its strength and rigidity can be optionally installed between fixed arms (111) and (112) as required;

Coupling structure (103): it is for coupling the U-shaped top end (113) of the U-shaped short frame (101) and the U-shaped bottom end (213) of the U-shaped long frame (201), wherein the coupling methods include (1) directly weld; or (2) weld by adding a patching clot; or (3) directly lock; or (4) lock by adding a fixed block; or (5) directly rivet; or (6) rivet by adding a fixed block; or (7) directly inlay; or (8) inlay by adding a fixed block; or other conventional coupling structures that enable said two U-shaped tube structure either to be coupled from separate status with functions to disassemble or to be perpetually coupled.

1. An automobile roof frame with X-shaped coupling structure, wherein it is related to an innovation of an automobile roof frame, more specifically it is a roof frame structure being forward and backward extended along both sides of the car body to bend downwardly and being forward and backward extended in parallel or approximately parallel, thereby to construct specified coupling structures; wherein it is mainly comprised as follows:
U-shaped short frame (101): it is a reversed U-shaped structure which is constituted by metal tube shape or stick shape material, wherein the fixed arms (111), (112) extending downward at both sides are combined to the front of the car body (100), and the U-shaped top end (113) and the U-shaped bottom end (213) of the U-shaped long frame (201) is coupled in X-shape at the coupling structure (103) to jointly constituted a roof frame. The fixed arms (111), (112) extended at both sides of the U-shaped short frame (101) can be constituted by a single tube, or can be optionally installed with an auxiliary arm as required to constitute multi-arms that combined to the car body (100); a transverse arm (114) to improve its strength and rigidity can be optionally installed between fixed arms (111) and (112) as required;
U-shaped long frame (201): it is an U-shaped structure which is constituted by metal tube shape or stick shape material, wherein its both sides are extended toward top portion for disposing a roof device (200), or an optionally installed windshield and related apparatus before the fixed arms (211), (212) are extended downward to be combined with the rear of the car body (100), and the U-shaped long frame (201) leading to the U-shaped bottom end (213) at front and the U-shaped top end (113) of the U-shaped short frame (101) are coupled in X shape at the coupling structure (103) to jointly constitute the roof frame. The fixed arms (111), (112) extended at both sides of the U-shaped long frame (201) can be constituted by a single tube, or can be optionally installed with an auxiliary arm as required to constitute multi-arms that combined to the car body (100); a transverse arm (114) to improve its strength and rigidity can be optionally installed between fixed arms (111) and (112) as required;
Coupling structure (103): it is for coupling the U-shaped top end (113) of the U-shaped short frame (101) and the U-shaped bottom end (213) of the U-shaped long frame (201), wherein the coupling methods include (1) directly weld; or (2) weld by adding a patching clot; or (3) directly lock; or (4) lock by adding a fixed block; or (5) directly rivet; or (6) rivet by adding a fixed block; or (7) directly inlay; or (8) inlay by adding a fixed block; or other conventional coupling structures that enable said two U-shaped tube structure either to be coupled from separate status with functions to disassemble or to be perpetually coupled.

2. An automobile roof frame with X-shaped coupling structure as claimed in claim 1, wherein it includes constructing the front downward bended parallel or approximately parallel frame into multi-sectionally X-shaped coupling structure.

3. An automobile roof frame with X-shaped coupling structure as claimed in claim 1, wherein it includes constructing the rear downward bended parallel or approximately parallel frame into multi-sectionally X-shaped coupling structure.

4. An automobile roof frame with X-shaped coupling structure as claimed in claim 1, wherein it includes constructing the front and rear parallel or nearly parallel frame that bended downward along both sides of the car body into multi-sectionally X-shaped coupling structure.
